(19) United States
(12) Patent Application Publication
(10) Pub. No.: US 2002/0050260 A1
(43) Pub. Date: May 2, 2002

(54) Adaptable fluid flow apparatus

(76) Inventor: Roderick E. Harvey, Peterborough (GB)

Correspondence Address: CATERPILLAR INC., 100 N.E. ADAMS STREET, PATENT DEPT., PEORIA, IL, 616296490

(21) Appl. No.: 10/004,314

(22) Filed: Nov. 1, 2001

(30) Foreign Application Priority Data
Nov. 2, 2000 (GB) 0026751.8

(51) Int. Cl. F02M 35/10; F01N 7/10; F16L 43/00

(52) U.S. Cl. 123/184.21; 285/181; 285/414; 60/323

(57) ABSTRACT

Various installation arrangements for internal combustion engines, for example, may require a variety of different connection arrangements for fluid flow apparatus such as intake/exhaust manifolds, coolant flow apparatus, and the like. Consequently, a range of fluid flow bodies and connectors may be required for each engine model, leading to high unit costs and large inventories. An adaptable fluid flow apparatus according to this invention includes a fluid flow body and an elbow connector. The elbow connector can be mounted to the body in at least three positions so that the flow axis of the elbow connector lies along one of three substantially orthogonal axes. Moreover, the elbow connector can be positioned so that its flow axis lies either substantially parallel to or transverse to the longitudinal axis of the fluid flow body. The adaptable fluid flow apparatus in accordance with this invention permits one set of parts to be adapted to various engine installations, thus reducing unit cost and lowering inventory requirements.

### TECHNICAL FIELD

This invention relates to an adaptable fluid flow apparatus and, more particularly, to an adaptable fluid flow apparatus for an internal combustion engine, such as an air inlet manifold or the like.

### BACKGROUND

When internal combustion engines of a common basic type are adapted to suit different machines (for example, tractors, excavators, trucks, boats or generating sets), it is common for fluid-flow bodies such as air inlet manifolds, exhaust outlet manifolds and coolant flow bodies to be fitted with a fluid-flow connector at a front end or at a rear end, and for the connector to be positioned with a spout or pipe facing upwards, forwards or outwards, or in an intermediate direction, to suit the individual engine installation requirements.

The connector is used to adapt the engine to an air intake system, exhaust system, or coolant system mounted on the machine to which the engine is fitted. The connector may be integral with the fluid-flow body, e.g. cast or molded as a unit with the body, or it may be a separate item secured to the body with threaded fasteners or by other conventional means.

As a result of the need for different connector locations and angular attitudes on a fluid flow body, requirements frequently arise for a range of bodies and connectors differing in construction only in their provision for connector location and angular attitude. These variable requirements lead to relatively high unit cost and high inventory levels for the fluid flow bodies and their associated connectors.

A known example of an adjustable pipe bend connector is described in PCT Publication WO 87/00601 published Jan. 29, 1987. The connector is angularly adjustable by means of an intersection between two half portions. Each half portion is provided with an annular flange defining mating surfaces. Each half portion can be rotated in relation to the other to give an included angle between the two half portions of 90° to 180°. The connector is made up of an assembly of several parts and is likely to be expensive to manufacture and bulky. The connector does not provide alternative connector locations with respect to a fluid flow body.

This invention is directed at providing an adaptable fluid flow apparatus that provides a solution to one or more of the problems identified above.

### SUMMARY OF THE INVENTION

In one aspect of this invention, an adaptable fluid flow apparatus comprises a fluid flow body having a longitudinal axis and a mounting face oriented in a transverse plane definable by an angle, β, with reference to the longitudinal axis. A fluid flow connector is mountable on the mounting face and includes an elbow extending at an angle, α, to define an elbow flow axis. The mounting face and the fluid flow connector being co-operable to orient the elbow flow axis of the fluid flow connector along three substantially orthogonal axes.

In another aspect of this invention, an adaptable fluid flow apparatus comprises a fluid flow body and an elbow connector connected with the fluid flow body. The elbow connector has a fluid passage opening at a first end to the fluid flow body and defining an elbow flow axis at a second end thereof. The fluid flow connector is selectively positionable relative to the fluid flow body in at least three rotary positions with the elbow flow axis lying along one of three substantially orthogonal axes in each of the three rotary positions.

In yet another aspect of this invention, an adaptable fluid flow apparatus comprises a fluid flow body having a longitudinal axis and an elbow connector having a fluid passageway opening at a first end to the fluid flow body and defining an elbow flow axis at a second end thereof. The fluid flow connector is selectively positionable relative to the fluid flow body in at least a first position in which the elbow flow axis is substantially parallel to the longitudinal axis and a second position in which the elbow flow axis is transverse to the longitudinal axis.

### BRIEF DESCRIPTION OF THE DRAWINGS

FIG. 1 is a side view of a first embodiment of an adaptable fluid flow apparatus in accordance with this invention including a fluid-flow body in the form of an air inlet manifold fitted with a fluid flow connector.

FIG. 2 is an isometric view of the adaptable fluid flow apparatus of FIG. 1 showing three orthogonal axes along which the connector may be disposed.

FIG. 3 is an isometric view of the fluid flow connector.

FIG. 4 is a cross-sectional view along the line IV-IV of the fluid flow connector of FIG. 3.

FIG. 5 is an isometric view of an alternative fluid flow connector in the form of a two-part assembly.

FIG. 6 is a cross-sectional view along the line VI-VI of the fluid flow connector of FIG. 5.

FIG. 7 is an isometric view of an alternative embodiment of the invention in which the fluid flow body is in the form of a two-part manifold fitted with a fluid-flow connector.

### DETAILED DESCRIPTION

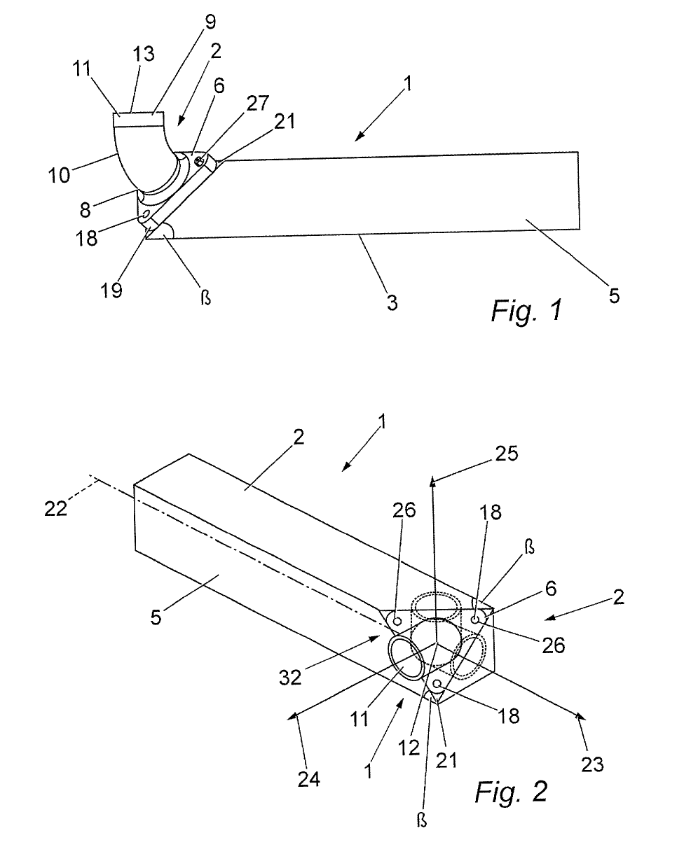

With reference to FIGS. 1 and 2, an adaptable fluid flow apparatus in accordance with this invention is generally indicated by the reference numeral 1. The fluid flow apparatus 1 includes a fluid flow connector 2 mounted on a fluid flow body 3. The fluid flow connector 2 is shaped to define an elbow 4 and thus may be referred to as an elbow connector. The fluid flow body 3 is in the form of an elongate manifold 5. The fluid flow connector 2 is co-operable with the elongate manifold 5 to provide a range of fluid flow connector 2 mounting positions and angular attitudes.

The fluid flow connector 2 includes a triangular mounting flange 6 and a pipe-like connector body 7 upstanding therefrom having an inlet end 8 and an outlet end 9. An arcuate pipe portion 10 is defined between the inlet end 8 and the outlet end 9 at the elbow 4. The connector body 7 has a fluid flow passage 11 defined between the inlet end 8 and the outlet end 9 which extends between an inlet 12 having a circular cross-section at the inlet end 8 and an outlet 13 having a circular cross-section at the outlet end 9 of the connector body 7. The inlet 12 facilitates fluid flow between the manifold 5 and the fluid flow connector 2.

Although the fluid-flow connector 2 is described herein as being pipe-like in construction, it will be appreciated by those skilled in the art that the fluid-flow connector 2 can vary in construction and can be for example an aspirator, conduit, discharge, dispenser, filter, flue, hose, nozzle, outlet, port, tube or the like.

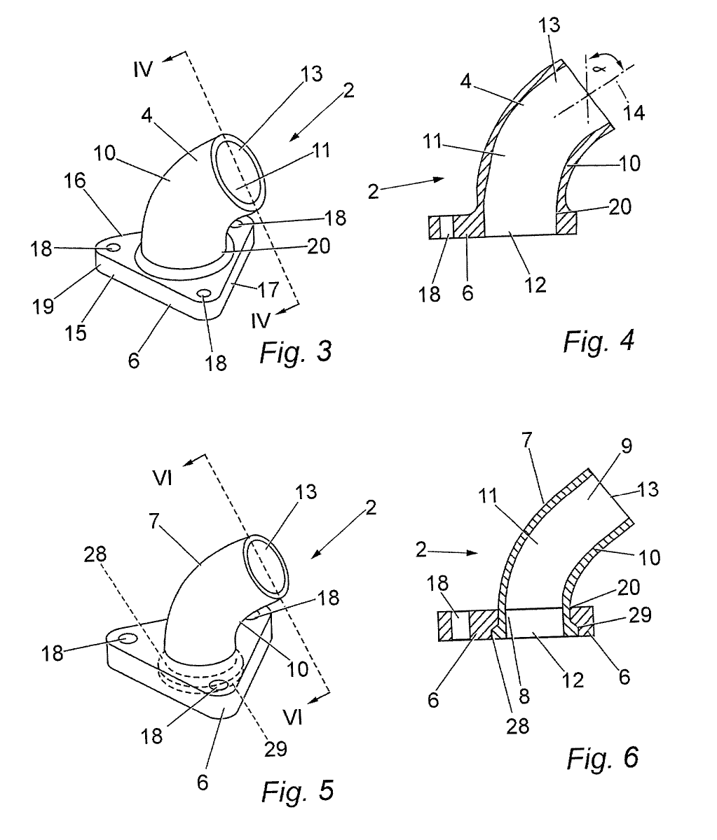

With reference also to FIGS. 3 and 4, the pipe-like connector body 7 defines a central longitudinal axis 14, which may also be referred to as an elbow flow axis 14. The arcuate pipe portion 10 is curved at an angle, α, of about 55° at the elbow 4 defined between the inlet end 8 and the outlet end 9 with respect to the longitudinal axis 14. It will be appreciated by those skilled in the art that where the fluid flow connector body 7 is formed from a flexible material the angle a can have a tolerance which is accommodated by the inherent flexibility of the fluid flow connector body 7.

The arcuate pipe portion 10 is unitary or integral with the mounting flange 6 and includes a base portion 20 disposed adjacent the flange 6 and communicable with the inlet 12 and the contiguous arcuate pipe portion 10 to facilitate fluid flow through the fluid flow connector 2. The arcuate pipe portion 10 terminates at the outlet 13. The mounting flange 6 is substantially triangular in shape and has a first flange side wall 15, a second flange side wall 16 and a third flange side wall 17. The mounting flange 6 is further provided with three fastener holes 18—one at each apex 19 of the triangular mounting flange 6—to facilitate fastening of the fluid flow connector 2 to the manifold 5 as shall be explained more fully below.

Referring now to FIGS. 1 and 2, the elongate manifold 5 is shown as a cuboid but may be of any shape known in the art. The manifold 5 is provided with a mounting face 21 for receiving the mounting flange 6 of the fluid flow connector 2. As explained more fully below, the mounting face 21 is oriented in a plane on the manifold 5 to co-operate with the angle, α, of the arcuate pipe portion 10 so that the longitudinal axis 14 of the connector body 7 may be disposed in any alternative one of three substantially orthogonal axes 23, 24, 25. The elongate manifold 5 has a manifold longitudinal axis 22, and as apparent from FIG. 2, the elbow flow axis 14 of the connector body 7 may be disposed either substantially parallel to the longitudinal axis 22 or transverse to the longitudinal axis 22. The connector mounting face 21 is disposed in a transverse plane 32 which intersects the axis 22 at an angle, β, of about 45° from the horizontal so that it faces generally outwards and upwards. Accordingly, when the longitudinal axis 22 is disposed in a horizontal disposition the transverse plane 32 is inclined at an angle, β, of about 45°. The angle of curvature, α, of 55° of the arcuate pipe portion 10 in combination with the inclination of the transverse plane 32 defined by the angle, β, facilitates the orientation of the longitudinal axis 14 of the connector body 7 along the three orthogonal axes 23, 24, 25 by rotating the triangular mounting flange 6 on the mounting face 21 through 120° intervals. Accordingly, rotation of the fluid flow connector body 7 through 120° segments on the mounting face 21, as shown in FIG. 2, provides three alternative axial 90° interval orientations of the connector body 7 namely along the axes 23, 24, 25. The fluid flow connector 2 is secured in any of said positions on the mounting face 21 at the fastener holes 18. The fastener holes 18 correspond with three tappings 26 in the mounting face 21 of the manifold 5 so that the fluid flow connector 2 may be secured to the manifold 5 with threaded fasteners 27 in any one of the three alternative positions described above. The angle α of the elbow 4 in combination with the angle of inclination, β, of the transverse plane 32 facilitate orientation of the fluid flow connector body 7 along the three orthogonal axes 23, 24, 25. An angle, α, of 54.736° has been found to be particularly efficacious in combination with an angle, β, of 45°.

FIGS. 5 and 6 describe a modification of the fluid flow connector of FIGS. 1 to 4 where the fluid flow connector 2 is a two-part assembly in which the connector body 7 is rotatably mounted on the mounting flange 6. Otherwise the adaptable fluid flow apparatus 1 is broadly similar to the fluid flow apparatus 1 of FIGS. 1 to 4 and accordingly, like numerals indicate like parts.

The two-part fluid flow connector 2 is useful for situations where axial orientations of the fluid flow connector body 7 intermediate the three orthogonal axes 23, 24, 25 are required or where it is necessary to vary the axial orientation intermittently. The fluid flow connector body 7 and the mounting flange 6 are separate connectable components. The fluid flow connector body 7 is provided with an outwardly depending skirt 28 at the inlet 12. The skirt 28 is received in a complementary recess 29 in the mounting flange 6. The skirt 28 is rotatable in the recess 29 to facilitate the variation in the axial position of the connector body 7 with respect to the mounting face 21.

The connector body 7 can be clamped at any required rotational position in the mounting flange 6 when the mounting flange 6 is fastened to the manifold 5 without requiring removal of the connector body 7. Orientation of the fluid flow connector body 2 along the orthogonal axes 23, 24, 25 can therefore be achieved, together with any desired intermediate positions.

It will be appreciated by those skilled in the art that the mounting flange 6 can be of any desired shape. The mounting flange 6 must simply be capable of being mounted on the mounting face 21. For example, in one alternative embodiment of the invention (not shown), the mounting flange 6 and, if desired, the mounting face 21 may be circular rather than triangular in shape and may thus be provided with a plurality of holes on a pitch circle to provide flexibility of rotational position of the fluid flow connector 2. Consequently, the mounting flange 6 could be either integral with the connector body 7 or the fluid flow connector 2 can be in the form of a two-part assembly as described in FIGS. 5 and 6. In other embodiments of the invention (not shown), the mounting flange 6 could be bonded or welded to the mounting face 21 on the manifold 5. Alternatively, a bayonet fitting (not shown) could be employed in place of the triangular or circular flange 6. For example, a suitably configured three-lug bayonet could provide the three alternative 90° rotational positions of the fluid flow connector 2 that would otherwise be constructed as described herein. In still another alternative embodiment of the invention (not shown), the connector body 7 may be formed from contiguous sub-pipe portions that in combination define the angle α instead of a single fluid flow connector body 7.

As will be appreciated by those skilled in the art, the manifold 5 can be configured to be longitudinally reversible to locate the mounting face 21 at an alternative end of the manifold 5. However, it should be noted that reversal of the manifold 5 results in reversal of one of the orientations of the three orthogonal axes 23, 24, 25. Specifically, the previously upward facing pipe position would become a downward facing alternative position. This may be desirable or undesirable, depending upon particular engine installation requirements. Alternatively, each end of the manifold 5 can be of a mirrored construction so as to duplicate the available fluid flow connector 2 mounting faces 21. Alternatively or additionally, one or more connector mounting faces 21 may be provided at any location along the manifold 5. Any unused mounting face 21 may be blanked off by conventional means.

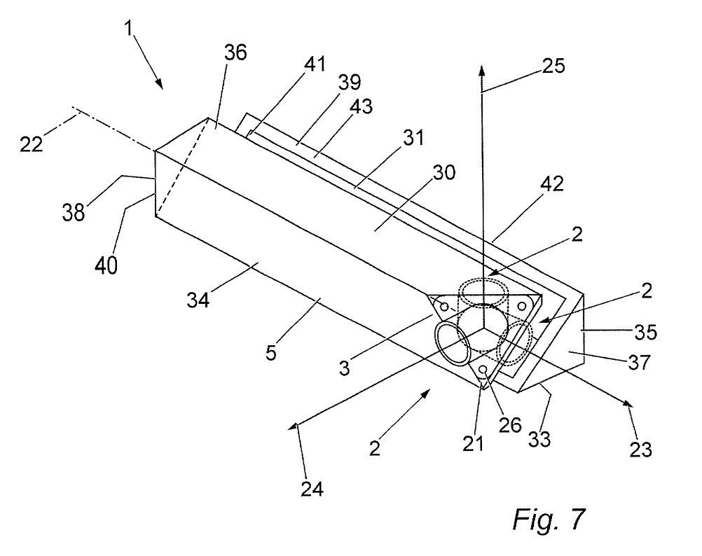

FIG. 7 describes a modification of the manifold 5 of FIGS. 1 and 2 where the manifold 5 is a two-part assembly. The manifold 5 of the present embodiment is broadly similar to the manifold previously described. Accordingly, like numerals indicate like parts. The manifold 5 is made up of a cuboid housing 42 and has a substantially square-shaped cross-section. Of course, a non-cuboid housing having some other cross-sectional shape could be used if desired. The housing 42 is provided with a bottom wall 33, a front wall 34, a side wall 35, a top wall 36, a first end wall 37 and a second end wall 38. In the present embodiment, the elongate cuboid manifold housing 42 is made up of two parts—a manifold housing first or front part 30 and a manifold housing second or rear part 31. The manifold housing 42 is split into two parts along a transverse plane 39 to sub-divide the end wall 38 into a front part triangular portion 40 and a rear part triangular portion 41.

The manifold housing front part 30 is made up of the top wall 36, the front wall 34, the mounting face 21 and the front part triangular portion 40. The manifold housing rear part 31 is made up of the bottom wall 33, the rear wall 35, the rear part triangular portion 41, and the end wall 37. The manifold front part 30 bearing the single connector mounting face 21 is longitudinally reversible in relation to the rear part 31 to give identical 90°-interval pipe rotational angle options at each end. The manifold housing front part 30 mates with the manifold housing rear part 31 at a transverse mating flange 43 angled at 45° from top rear to bottom front. Thus, longitudinally reversing the manifold housing front part 30 moves the connector mounting face 21 from a first end to a second end yet still provides 90° interval, vertically up, horizontally forward or horizontally outward orthogonal positions 23, 24, 25 respectively of the connector body 7 in relation to the manifold 5, plus any desired intermediate positions.

The manifold housing front part 30 is attachable to the manifold housing rear part 31 to form the manifold housing 42. The manifold housing front part 30 can be selected so that the housing front part 30 is configured in accordance with the requirements of the engine installation. Accordingly, the two-part manifold can be constructed by selecting a manifold housing front part 30 in accordance with an engine installation and attaching the manifold housing front part 30 to a manifold housing rear part 31 to form the manifold housing 42 in accordance with the required application for the manifold 5. In the present embodiment the manifold housing rear part 31 may be incorporated in or integral with an adjacent substructure (e.g. a cylinder head). The two-part manifold 5 can, depending on the application, have a number of benefits, e.g. help facilitate casting or molding. The front and rear manifold housing 30, 31 parts may be joined by threaded fasteners, adhesive bonding or other attachment means.

### INDUSTRIAL APPLICABILITY

In use, the adaptable fluid flow apparatus of this invention permits a single design to be applied to a variety of applications. In the case of a fluid flow apparatus for an internal combustion engine, for example, one set of parts may be use for multiple applications of one engine model regardless of whether the elbow connector must extend upwards, to one side, or even parallel to the fluid flow body to suit each particular application. Prior to assembly to the engine, the required position of the elbow connector is determined, and the connector is then assembled onto the fluid flow body in the proper orientation. One fluid flow body configuration and one elbow connector configuration can be used for each engine model regardless of the engine application and manifold connection requirements. As a result, fewer different parts are required, thus leading to lower unit costs and lower inventories for production components and service parts.

As will be apparent to those skilled in the art, this invention is applicable to a variety of fluid flow applications and is not limited to engine applications. Those skilled in the art will also recognize that, with respect to engine fluid flow apparatus, this invention is not limited to air inlet manifolds in engines. Thus, it should be understood that the invention is not restricted to a component of this particular configuration and may be adapted to a wide range of fluid flow applications e.g. in coolant systems where the fluid flow apparatus can provide alternative fluid flow connector angles and locations on a coolant body.

Various additions or modifications may be made to the embodiments described above without departing from scope of the following claims.

What is claimed is:

1. An adaptable fluid flow apparatus comprising:
a fluid flow body having a longitudinal axis and a mounting face oriented in a transverse plane definable by an angle, β with reference to said longitudinal axis; and
a fluid flow connector having a longitudinal axis and mountable on the mounting face, the fluid flow connector including an elbow extending at an angle, α, to define an elbow flow axis, the mounting face and the fluid flow connector being co-operable to orient the elbow flow axis of the fluid flow connector along three substantially orthogonal axes.

2. The fluid flow apparatus of claim 1 wherein the transverse plane is disposed at an angle, β, of about 45° with reference to the longitudinal axis of the fluid flow body and the elbow is defined by an angle, α, of about 55° with reference to the elbow flow axis of the fluid flow connector.

3. The fluid flow apparatus of claim 1 wherein the fluid flow body comprises a manifold.

4. The fluid flow apparatus of claim 3 wherein the manifold comprises a two-part manifold having:
a first manifold housing part; and
a second manifold housing part attachable to the first manifold housing part to form a manifold housing;
the mounting face being located on one of the first or second manifold housing parts.

5. The fluid flow apparatus of claim 1 wherein the fluid flow connector includes a mounting flange and a tubular portion, and wherein said tubular portion is rotatable relative to said mounting flange.

6. The fluid flow apparatus of claim 1 wherein the fluid flow connector includes a mounting flange and a tubular portion, and wherein said tubular portion is rotationally fixed relative to said mounting flange.

7. An adaptable fluid flow apparatus, comprising:
a fluid flow body; and
an elbow connector connected with said fluid flow body, said elbow connector having a fluid passage opening at a first end to said fluid flow body and defining an elbow flow axis at a second end thereof, said fluid flow connector beings selectively positionable relative to said fluid flow body in at least three rotary positions, said elbow flow axis lying along one of three substantially orthogonal axes in each of said three rotary positions.

8. The adaptable fluid flow apparatus of claim 7 wherein said elbow connector comprises a mounting flange and a tubular portion defining said fluid passageway, and wherein said tubular portion is rotatable relative to said mounting flange.

9. The adaptable fluid flow apparatus of claim 7 wherein said elbow connector comprises a mounting flange and a tubular portion defining said fluid passageway, and wherein said tubular portion is rotationally fixed relative to said mounting flange.

10. An adaptable fluid flow apparatus, comprising:
a fluid flow body having a longitudinal axis; and
an elbow connector having a fluid passageway opening at a first end to said fluid flow body and defining an elbow flow axis at a second end thereof, said fluid flow connector being selectively positionable relative to said fluid flow body in at least a first position in which said elbow flow axis is substantially parallel to said longitudinal axis and a second position in which said elbow flow axis is transverse to said longitudinal axis.

11. The adaptable fluid flow apparatus of claim 10 wherein said elbow flow axis is substantially orthogonal to said longitudinal axis when said elbow connector is in said second position.

12. The adaptable fluid flow apparatus of claim 10 wherein said fluid flow connector is selectively positionable relative to said fluid flow body in at least a third position which said elbow flow axis is transverse to said longitudinal axis and also transverse an axis along which said elbow flow axis lies when in said second position.

13. The adaptable fluid flow apparatus of claim 12 wherein said elbow flow axis is substantially orthogonal to said longitudinal axis when said elbow connector is in either of said second or third positions.

14. The adaptable fluid flow apparatus of claim 13 wherein said elbow flow axis, when in said third position, is substantially orthogonal to the axis along with said elbow flow axis lies when in said second position.

15. The adaptable fluid flow apparatus of claim 10 wherein said elbow connector comprises a mounting flange and a tubular portion defining said fluid passageway, and wherein said tubular portion is rotatable relative to said mounting flange.

16. The adaptable fluid flow apparatus of claim 10 wherein said elbow connector comprises a mounting flange and a tubular portion defining said fluid passageway, and wherein said tubular portion is rotationally fixed relative to said mounting flange.

17. The adaptable fluid flow apparatus of claim 7 wherein said fluid flow apparatus is a fluid flow apparatus for an internal combustion engine selected from the group consisting of an air inlet manifold, an exhaust manifold, and a coolant flow apparatus.

18. The adaptable fluid flow apparatus of claim 10 wherein said fluid flow apparatus is a fluid flow apparatus for an internal combustion engine selected from the group consisting of an air inlet manifold, an exhaust manifold, and a coolant flow apparatus.
